(19) United States
(12) Patent Application Publication
(10) Pub. No.: US 2006/0193576 A1
(43) Pub. Date: Aug. 31, 2006

(54) JACKET ASSEMBLY FOR A CABLE

(75) Inventors: Michael E. Lester, Burton, OH (US); Lori Parker-Darash, Duncan, SC (US)

Correspondence Address: PEARNE & GORDON LLP, 1801 EAST 9TH STREET, SUITE 1200, CLEVELAND, OH, 44114-3108, US

(73) Assignee: ELECTROLOCK INCORPORATED, Hiram, OH (US)

(21) Appl. No.: 11/380,179

(22) Filed: Apr. 25, 2006

Related U.S. Application Data
(62) Division of application No. 10/051,694, filed on Jan. 18, 2002.

(51) Int. Cl. G02B 6/44

(52) U.S. Cl. 385/114; 385/128

(57) ABSTRACT

A method and apparatus for loading a ribbon cable into a protective jacket. A leader with a first end and a second end is enclosed in the jacket. The second end of the leader is then attached to the cable, while the first end of the leader is used for pulling the leader through the jacket. The first end of the leader is then pulled through the jacket until a parallel wire section of the cable is exposed. The exposed wires are then cut to length resulting in the ribbon cable being loaded into the protective jacket and ready for installation.

### CROSS-REFERENCE TO RELATED APPLICATIONS

This application is a division of U.S. patent application Ser. No. 10/051,694 filed on Jan. 18, 2002, which is incorporated herein by reference.

### BACKGROUND OF THE INVENTION

1. Field of the Invention

This invention relates generally to a method and apparatus for loading a ribbon cable into a jacket.

2. Description of the Related Art

Ribbon cables are used in the wiring of medium and large scale electronic equipment such as computer hardware. A significant cost-savings is realized by using ribbon cable versus stringing individual conductors because mass termination techniques may be employed with ribbon cables.

Mass terminating can only occur on a segment of a ribbon cable in which the wires are essentially straight and parallel to one another. Yet in most instances, the major portion of the wire pairs in a ribbon cable are twisted and mass terminating cannot occur in the twisted portion. Twisted pair multi-conductor ribbon cables are thus designed with intermittent parallel wire sections that are used to cut the ribbon cable to length for mass termination.

A twisted pair multi-conductor ribbon cable should be cut at the intermittent parallel sections to length before it is placed within a protective jacket.

There are many types of ribbon cable assemblies available. U.S. Pat. No. 5,367,123 to Plummer, III et al. discloses a tubular sheath for a ribbon cable in which a strip is folded around the ribbon cable to form the sheath.

U.S. Pat. No. 4,837,405 to Bonjour et al. discloses an insulating jacket containing rolled ribbon cable in which markings are placed on the outside of the jacket to indicate where bonded sections of the ribbon cable are located.

U.S. Pat. No. 4,992,625 to Izui et al. discloses a ribbon cable with a sheath, in which the sheath has bonded and non-bonded segments and the ribbon is rolled into an s-shape and encased in the sheath.

It is desirable to provide a device that can load a ribbon cable into a protective jacket before the cable is cut to its required installation length.

### SUMMARY OF THE INVENTION

In accordance with one aspect, the present invention provides a loading device for a ribbon cable. The device includes a leader with a first end and a second end with a jacket enclosing the leader. The device also includes means for attaching the second end of the leader to the cable. The first end of the leader is used for pulling the leader through the jacket.

In accordance with another aspect of this invention, it is further desirable to provide a method of loading a ribbon cable inside a jacket. The method comprising the steps of extruding a leader inside a jacket, cutting the jacket with the leader extruded inside to length, attaching one end of the leader to the cable, pulling the leader through the jacket until a parallel wire section of the cable is exposed at an end of the jacket and cutting the ribbon cable at the exposed parallel wire section to length.

In accordance with another aspect of this invention, it is further desirable to provide a method of making a ribbon cable enclosed inside a jacket to a specified length. The method comprising the steps of cutting a leader to length, extruding a jacket over the leader, cutting the jacket with the leader extruded inside to length, providing a ribbon cable, attaching one end of the leader to the ribbon cable, pulling the leader through the jacket until a parallel wire section of the ribbon cable is exposed at an end of the jacket, and cutting the ribbon cable to length.

These and other aspects of this invention are illustrated in the accompanying drawings, and are more fully disclosed in the following specification.

### BRIEF DESCRIPTION OF THE DRAWINGS

FIG. 1 is a perspective view of a ribbon cable with parallel and twisted wire sections;

FIG. 2 is a perspective view of a leader enclosed within a jacket as provided for in the present invention;

FIG. 3 is a perspective view of a ribbon cable attached to the second end of a leader for loading a ribbon cable as provided for in the present invention; and

FIG. 4 is a perspective view of a ribbon cable loaded with the jacket and the parallel wires of the cable cut to length as provided for in the present invention.

### DETAILED DESCRIPTION OF THE INVENTION

The invention can provide a jacket or sheath equipped with a leader that is designed to load a cable into a jacket before the cable is cut to its required installation length.

In particular, the invention provides for a loading device for a cable, the loading device consists of a leader with a first end and a second end and a jacket enclosing the leader. The cable is attached to the second end of the leader and the first end of the leader is used for pulling the leader through the jacket.

More specifically, a ribbon cable is configured such that it should only be cut at certain intervals where parallel sections of individual insulated wires are bonded together. Thus, it is not desirable to extrude the sheath directly around the ribbon cable, since this would prevent the proper cutting locations from being easily located. Therefore, the ribbon cable may be cut to length after it is placed within a protective jacket.

Accordingly, in order to facilitate easy loading of the ribbon cable into the jacket, the jacket is extruded around a leader, for example, a continuous strip of felt that has approximately the same dimensions as the ribbon cable. By pulling the leader through the jacket, the ribbon cable is easily loaded into the jacket. In addition to having the required strength for the loading operation, the leader should be from a desirable material that elongates and narrows as it is pulled through the jacket. This necking down of the leader allows it to pull away from the inner walls of the jacket and to pass more easily through the jacket.

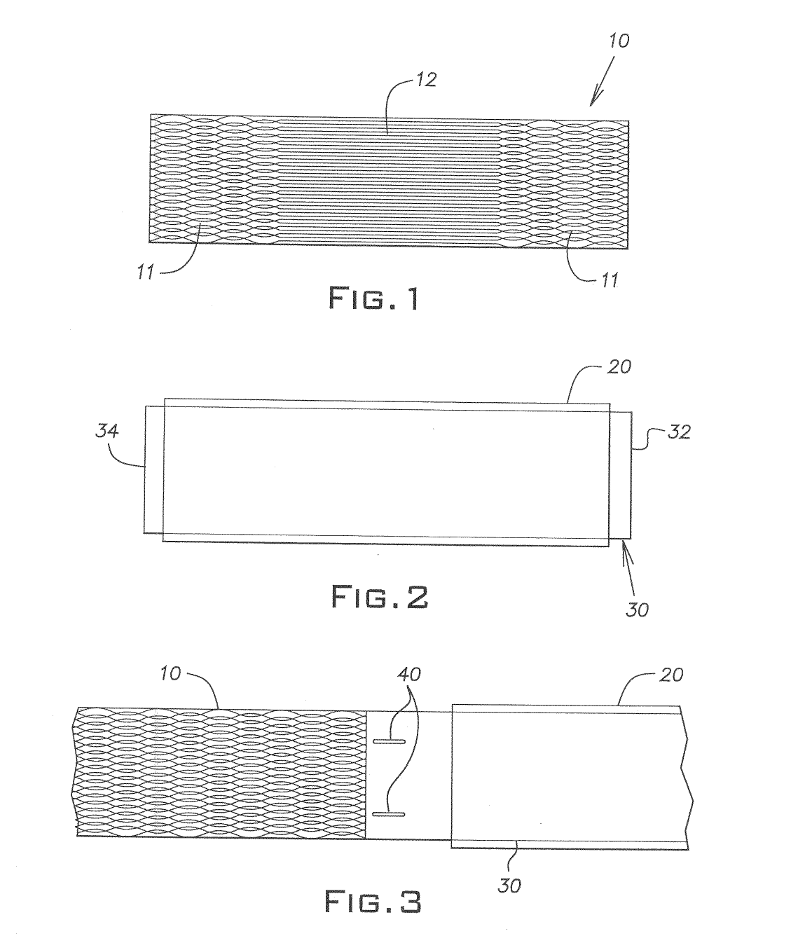

Referring now to FIG. 1, shown is an example of a cable, for example, a twisted pair multi-conductor cable 10, or a ribbon cable with parallel 12 and twisted wire sections 11. The cable 10 is configured such that it should only be cut at certain intervals where parallel insulated wires 12 are bonded together. In the present invention, the cable 10 may be cut to its final length at these certain intervals after it is placed within a jacket 20.

As shown in FIG. 2, the jacket may be extruded around a leader 30 that may be cut to a predetermined length from a longer length, such as from a supply roll. The leader 30 may be cut to a length that is approximately the same dimension as the cable 10.

The leader 30, for example, may comprise a continuous piece of felt. In addition to having the required strength for the loading operation, the felt 30 is a desirable material for this purpose because it elongates and narrows as it is pulled through the jacket 20. This necking down of the felt allows it to pull away from the inner walls of the jacket and to pass more easily through the jacket 20. The following table specifies example property values for felt materials, as for example, for a white non-woven polyester felt via a needle loom 6 denier, 2 inch min., staple polyester fibers which are mechanically interlocked.

| Properties | Units | Value |
|---|---|---|
| Tensile | lbs | 125-200 |
| Elongation | % | 75-125 |
| Thickness | inches | 0.02-0.20 |
| Weight | oz/yd² | 2-20 |
| Width | inches | ⅛-15 |

The jacket 20, for example, may comprise a thin wall PVC compound, or vinyl jacket. The following table specifies example property values for jacket materials, as for example, for an EX-1911 Natural PVC Compound Pigmented black.

| Properties | Units | Value |
|---|---|---|
| Color | Munsell | Black N1.5 |
| Extrusion Thickness | Inches | 0.005-0.100 |
| Specific Gavity | | 1.0-1.6 |
| Shore A Hardness | | 40-100 |
| Tensile Strength | psi | 2250 |
| Elongation | % | 365 |
| 100% Modulus | psi | 1165 |
| Oxygen Index | | 10-50 |
| UL 94 Vertical burn | .075″ sample | V-0 |
| UL 94 Thin Wall | | VTM-0 |

Referring to FIG. 3, once the leader and jacket combination is cut to length, the ribbon cable 10 can be attached by means 40 to an exposed end (e.g., a second end 34) of the leader 30. A first end 32 of the leader 30 is used by an operator to grab and pull the leader through the jacket 20, with the second end 34 of the leader being attached to the ribbon cable 10 by the attachment means 40. (e.g., by a fastener).

As shown by the example in FIG. 3, the leader maybe attached by the use of staples 40 as the attachment means. Other types of attachment means that produce similar tension strength may also be utilized. These attachment means 40 may include adhesives, clips and bands.

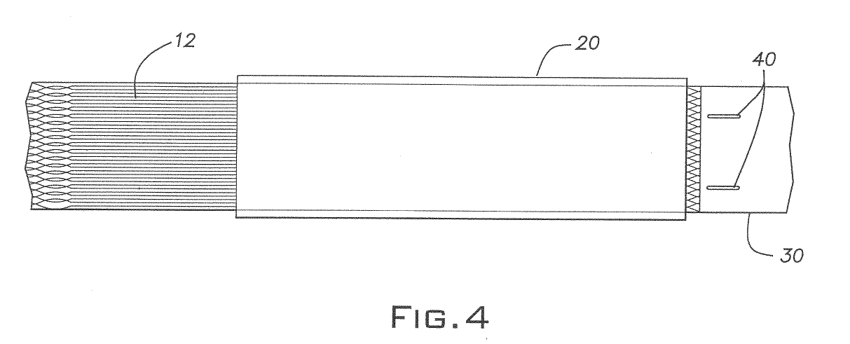

By pulling the leader 30 through the jacket 20, as shown in FIG. 4, the ribbon cable 10 is easily loaded into the jacket and may be cut to length at the parallel wire section 12.

Although the invention has been shown and described with respect to certain embodiments, it is obvious that equivalent alterations and modifications will occur to others skilled in the art upon reading and understanding of the specification. The present invention includes all such equivalent alterations and modifications, and is limited only by the scope of the claims.

What is claimed is:

1. A jacket assembly for a cable, the jacket assembly comprising:
an elongated jacket comprising a first open end and a second open end;
a strip-shaped felt leader extending within the jacket from the first open end to the second open end;
a first end of the leader for attachment to a ribbon cable by at least one of a fastener, an adhesive, a staple, a clip and a band; and
a second end of the leader for pulling the leader out of the elongated jacket while the first end of the leader pulls the ribbon cable into the elongated jacket,
wherein the jacket has been formed around the felt leader, the felt leader having dimensions that are approximately the same as dimensions of the ribbon cable, and
wherein the felt leader narrows when the leader is elongated by a pulling force applied to the second end causing the felt leader to pull away from the jacket.

2. A jacket assembly according to claim 1, wherein the jacket has been extruded around the felt leader.

3. A jacket assembly according to claim 1, wherein the jacket comprises a polymer.

4. A jacket assembly according to claim 1, wherein the jacket comprises vinyl.

5. A jacket assembly according to claim 1, wherein the jacket comprises a PVC compound.

6. A jacket assembly according to claim 1, wherein the felt leader comprises non-woven fibers for causing the felt leader to narrow as the leader is elongated by a pulling force applied to the second end.

7. A jacket assembly according to claim 1, wherein the felt leader comprises non-woven polyester fibers for causing the felt leader to narrow as the leader is elongated by a pulling force applied to the second end.

8. A jacket assembly according to claim 1, wherein the jacket assembly is provided as a roll for cutting off a desired length.
